(19) United States
(12) Patent Application Publication
(10) Pub. No.: US 2026/0220353 A1
(43) Pub. Date: Jul. 30, 2026

(54) SYSTEM AND METHOD FOR DYNAMICALLY ENRICHING PUBLICATIONS

(71) Applicant: AweScience, Ltd., Raanana (IL)

(72) Inventor: Joshua GLAZER, Raanana (IL)

(73) Assignee: AweScience, Ltd., Raanana (IL)

(21) Appl. No.: 19/040,389

(22) Filed: Jan. 29, 2025

(51) Int. Cl. G06F 40/166; G06F 40/40

(52) U.S. Cl. CPC G06F 40/166; G06F 40/40

(57) ABSTRACT

In some implementations, the device may include receiving main content and supplemental content for a publication, where the supplemental content supplements the main content and is associated with interactive elements at various enrichment points in the main content. In addition, the device may include receiving reader parameters, where the reader parameters include data about a reader. The device may include upon a reader selection of an interactive element of the interactive elements at an enrichment point, generating a prompt. Moreover, the device may include feeding the prompt to a large language model (LLM). Also, the device may include sending an output of the LLM to the reader, where the LLM is configured to receive further prompts from the reader.

### TECHNICAL FIELD

The present disclosure relates generally to generating publications that can be queried using artificial intelligence (AI) models.

### BACKGROUND

An interactive publication is a dynamic form of content that enhances the reader's experience by incorporating elements such as hyperlinks, QR codes, videos, and other multimedia features. These elements allow readers to access additional information, explore related topics, or engage with the content in various ways, transforming the reading experience from passive to active. This interactivity makes the content more engaging and informative, providing a richer and more immersive experience compared to traditional print or static digital formats.

However, interactive publications face certain challenges. One significant issue is the inability to consider a reader's personal data and to provide information that is personalized to the reader. This lack of personalization can result in a generic experience that may not fully account for data about the reader nor meet the reader's specific interests or needs, reducing the overall effectiveness of the interactive elements.

Another problem with traditional interactive publications is the difficulty in updating the information linked to the publication content. Once a hyperlink or QR code is embedded, updating the linked content can be cumbersome and time-consuming. This can lead to outdated or irrelevant information being presented to readers, diminishing the value of the interactive features.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, the method may include receiving main content and supplemental content for a publication, where the supplemental content supplements the main content and is associated with interactive elements at various enrichment points in the main content. The method may also include receiving reader parameters, where the reader parameters include data about a reader. The method may furthermore include upon a reader selection of an interactive element of the interactive elements at an enrichment point, generating a prompt. The method may in addition include feeding the prompt to a large language model (LLM). The method may moreover include sending an output of the LLM to the reader, where the LLM is configured to receive further prompts from the reader. Other embodiments of this aspect include corresponding computer systems, apparatus, and computer programs recorded on one or more computer storage devices, each configured to perform the actions of the methods.

Implementations may include one or more of the following features. Where the prompt is based on the reader parameters, the main content associated with the enrichment point, and the supplemental content associated with the selected interactive element. The method where the prompt is a pre-configured template that includes placeholders respectively allocated for the relevant main content, the relevant supplemental content, and reader parameters. The method may include: receiving interactions of a plurality of readers with a pre-defined prompt associated with a selected interactive element, where interactions include the content of further prompts fed by the plurality of readers to the LLM; and updating the pre-defined prompt based on common attributes of the interactions of the plurality of readers, where the pre-defined prompt is updated if there are a sufficient number of interactions with the common attributes. The method where when a publication is an electronic publication, the interactive elements are hyperlinks. The method where when a publication is a physical paper publication, the interactive elements are quick-response (QR) codes. The method where the supplemental content further includes at least one of: news feeds, weather feeds, and stock feeds. The method where reader parameters include at least one of: age, location, and time. The method where the LLM is configured to browse publicly available data over a network that is relevant to answering the prompt. The method where the publication is any one of: a printed document and a digital document. Implementations of the described techniques may include hardware, a method or process, or a computer tangible medium.

In one general aspect, non-transitory computer-readable medium may include one or more instructions that, when executed by one or more processors of a device, cause the device to: receive main content and supplemental content for a publication, where the supplemental content supplements the main content and is associated with interactive elements at various enrichment points in the main content; receive reader parameters, where the reader parameters include data about a reader; upon a reader selection of an interactive element of the interactive elements at an enrichment point, generate a prompt; feed the prompt to a large language model (LLM); and send an output of the LLM to the reader, where the LLM is configured to receive further prompts from the reader. Other embodiments of this aspect include corresponding computer systems, apparatus, and computer programs recorded on one or more computer storage devices, each configured to perform the actions of the methods.

In one general aspect, the system may include one or more processors configured to: receive main content and supplemental content for a publication, where the supplemental content supplements the main content and is associated with interactive elements at various enrichment points in the main content. The system may furthermore include receiving reader parameters, where the reader parameters include data about a reader. The system may in addition include upon a reader selection of an interactive element of the interactive elements at an enrichment point, generate a prompt. The System may moreover include feed the prompt to a large language model (LLM). The system may also include sending an output of the LLM to the reader, where the LLM is configured to receive further prompts from the reader. Other embodiments of this aspect include corresponding computer systems, apparatus, and computer programs recorded on one or more computer storage devices, each configured to perform the actions of the methods.

Implementations may include one or more of the following features. The system where the prompt is based on the reader parameters, the main content associated with the enrichment point, and the supplemental content associated with the selected interactive element. The system where the prompt is a pre-configured template that includes placeholders respectively allocated for the relevant main content, the relevant supplemental content, and reader parameters. The system where the one or more processors are further configured to: receive interactions of a plurality of readers with a pre-defined prompt associated with a selected interactive element, where interactions include the content of further prompts fed by the plurality of readers to the LLM; and update the pre-defined prompt based on common attributes of the interactions of the plurality of readers, where the pre-defined prompt is updated if there are a sufficient number of interactions with the common attributes. The system where when a publication is an electronic publication, the interactive elements are hyperlinks. The system where when a publication is a physical paper publication, the interactive elements are quick-response (QR) codes. The system where the supplemental content further includes at least one of: news feeds, weather feeds, and stock feeds. The system where reader parameters include at least one of: age, location, and time. The system where the LLM is configured to browse publicly available data over a network that is relevant to answering the prompt. The system where the publication is any one of: a printed document or a digital document. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example network diagram utilized to describe the various disclosed embodiments.

FIG. 2 is an example process diagram of prompt generation according to an embodiment.

FIG. 3 is an example flowchart of a process for dynamically generating a prompt based on, and in response to, a selection of an interactive element at an enrichment point in a publication.

FIG. 4 is an example flowchart 400 of a process for generating dynamically enriched publications.

FIG. 5 is an example schematic diagram of a prompt engine 130 according to an embodiment.

### DETAILED DESCRIPTION

The various disclosed embodiments include a method and system for generating personalized, dynamically-enriched publications. A publishing engine allows an author to create and store supplemental content for their published works in a database that can be selected and queried using a prompt engine that generates a prompt for a large language model (LLM) based on the published works, supplemental content, and details about the reader. The use of details about a reader in generating a prompt as well as the ability of an author to dynamically update the supplemental content associated with their published works efficiently yields more relevant, personalized, and current outputs of the LLM.

The disclosed invention uses a dynamic LLM-based approach to enrich the content of publications that allows for faster processing of data, reduced processing power, and the use of fewer computer resources compared to traditional methods. Because the disclosed invention associates supplemental content with interactive elements at various enrichment points and receives reader parameters, it allows for more accurate and relevant prompts and outputs of those prompts with less processing time and power required to yield such outputs.

Additionally, the disclosed invention allows for automating a subjective manual process. The human mind is not equipped to perform the disclosed embodiments of the present invention in a reliable, objective way because the human mind cannot practically perform the process of generating prompts based on reader parameters, the main content of a publication, and updated supplemental content that is dynamically coupled with pre-constructed interactive elements in the published works as disclosed herein. Further, the human mind cannot practically perform the process of updating prompts based on interactions of all readers with particular enrichment points in the main content. The disclosed embodiments allow for a consistent, objective generation of prompts based on reader parameters, reader feedback, main content, and supplemental content.

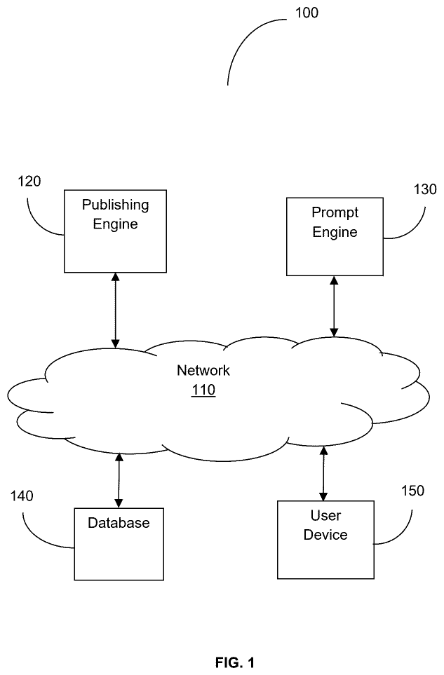

FIG. 1 shows an example network diagram 100 utilized to describe the various disclosed embodiments. In the example network diagram 100, a publishing engine 120, a prompt engine 130, a database 140, and a user device (UD) 150 communicate via a network 110. The network 110 may be, but is not limited to, a wireless, cellular, or wired network, a local area network (LAN), a wide area network (WAN), a metro area network (MAN), the Internet, the world wide web (WWW), similar networks, and any combination thereof.

The publishing engine 120 is configured to generate dynamically enriched publications. The publishing engine 120 receives main content and supplemental content of a publication from an author via a UD 150 through the network 110. The publishing engine 120 converts the main content into various media formats, including, but not limited to, Portable Document Format (PDF) and Microsoft® Word Document (DOC). Additionally, the publishing engine 120 generates interactive elements at enrichment points in the main content that link to the supplemental content that corresponds to the respective enrichment points in the main content. The interactive elements include but are not limited to a quick-response (QR) code or a hyperlink. An enrichment point is a point in the publication that indicates to a user, via the inclusion of an interactive element, that there is more information (supplemental content) that enriches the main content at that point in the publication.

An author, via a UD 150, can download the formatted documents from the publishing engine 120 over the network 110. In an embodiment, the formatted documents from the publishing engine 120 may be sent, over the network 110, to a publishing service including but not limited to an electronic publication distribution service or a paper publishing service. An electronic publication distribution service publishes electronic publications including but not limited to eBooks. A paper publishing service publishes physical publications including but not limited to paperbacks, hardcover books, and magazines.

In an embodiment, the publishing engine 120 generates interactive elements, such as QR codes, that are compatible with physical (e.g., paper) publications when the formatted document is published with a paper publishing service. In another embodiment, the publishing engine 120 generates interactive elements, such as hyperlinks, that are compatible with electronic publications when the formatted document is published with an electronic publication distribution service.

In an embodiment, the author may update the supplemental content after the interactive elements that link to the supplemental content are generated at a particular enrichment point. The author may make this update via the publishing engine 120. Such updates may be received and stored by the database 140. As a non-limiting example, an author may have published a book about longevity that included an interactive element at a particular enrichment point that links to a video of an exercise routine. After publication, the author may change the supplemental content to include an updated video of a new exercise routine that is based on new research, the author's experience, or any other reason. This embodiment will be discussed in more detail below.

The database 140 receives and stores the main and supplemental content of a publication from the publishing engine 120 over the network 110. In an embodiment, as explained above, the database 140 receives and stores any updated supplemental content that the author includes in the publication from the publishing engine 120.

The prompt engine 130 receives the main content and supplemental content of the publication from the database 140 over the network 110. The prompt engine 130 generates a prompt, based on the main content and the supplemental content, configured to be processed by at least one artificial intelligence (AI) model, including but not limited to a Large Language Model (LLM). The supplemental content used for the prompt generation is content that corresponds to a particular interactive element that a reader selects. In an embodiment, prompts are generated once a reader selects an interactive element. In another embodiment, prompts are pre-defined based on the enrichment point and content associated with the enrichment point.

In an embodiment, the prompt engine 130 also generates a prompt based on parameters of a reader, such as location, time, and any personal data. The prompt engine 130 may receive these parameters sent by the reader via the UD 150 over the network 110.

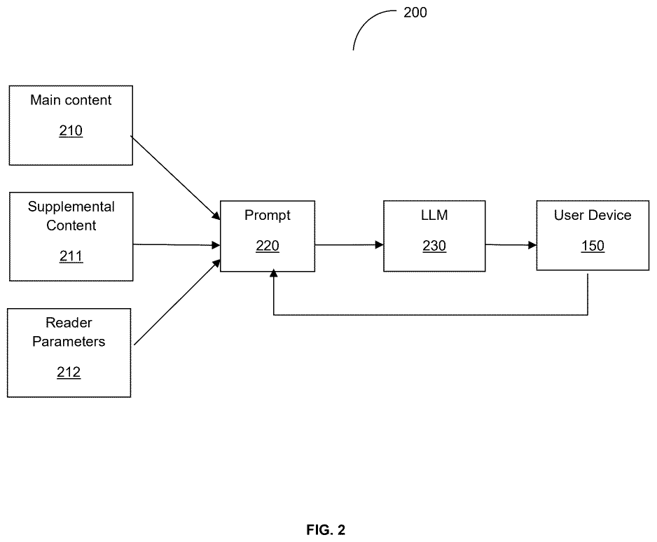

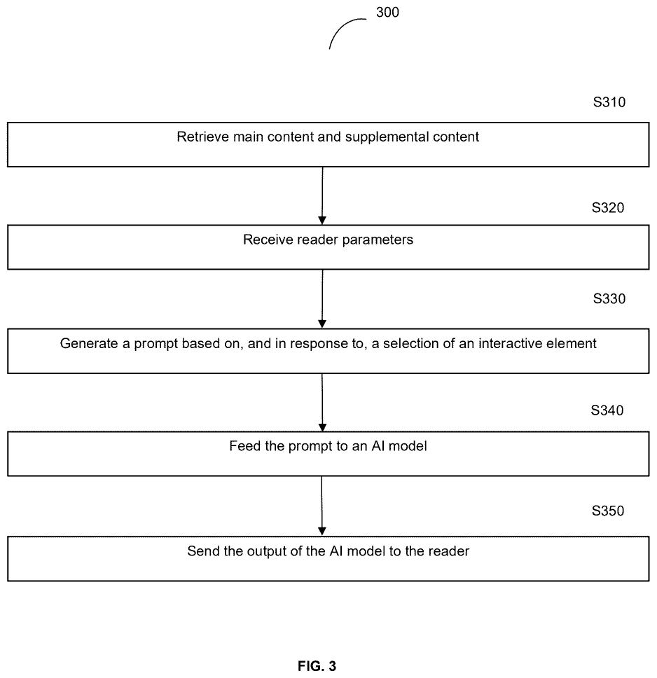

The generated prompt is fed to an LLM (not shown) as discussed in more detail with respect to FIGS. 2 and 3. The LLM, in an embodiment, has the ability to browse publicly available data via the network 110 based on the generated prompt.

The UD 150 may be, but is not limited to, a personal computer, a laptop, a tablet computer, a smartphone, a wearable computing device, or any other device capable of receiving and displaying notifications.

The UD 150 is configured to scan physical interactive elements from a physical publication such as, but not limited to, a QR code, and configured to display and enable a reader to select an electronic interactive element such as, but not limited to, a hyperlink.

Further, the UD 150 is configured to display the supplemental content that corresponds to the interactive element at the particular enrichment point that a reader selects. Additionally, the UD 150 is configured to display the queries and output of the AI model to the reader. The UD 150 allows the reader to send feedback and responses about the output to the prompt engine 130. The prompt engine 130 may adjust the prompt or send a new prompt to the LLM based on the feedback and responses.

In an embodiment, the prompt engine 130 is configured to display a pre-defined prompt to a reader via the UD 150 based on the enrichment point associated with the interactive element that a reader selects. According to this embodiment, the prompt engine 130 receives interactions with the pre-defined prompt at each enrichment point from a plurality of readers interacting with each enrichment point. Based on the content of the interactions with the pre-defined prompt, the prompt engine 130 updates the pre-defined prompt at periodic intervals to ensure that the prompt takes into consideration the preferences and interactions of a plurality of readers, not just one reader.

FIG. 2 is an example process diagram 200 of prompt generation according to an embodiment. In an embodiment, the process diagram 200 depicts the functions of the prompt engine 130 and its interactions with other elements of the network diagram 100, such as the UD 150.

Main content 210, supplemental content 211, and reader parameters 212 are used in the prompt 220. The contents 210, 211, and 212 may be obtained from different sources, such as news feeds, weather feeds, stock feeds, and the like. In an embodiment, the prompt includes a pre-configured template that includes placeholders respectively allocated for the contents 210, 211, and 212. In another embodiment, this prompt template is configured, by the prompt engine 130, based on the received contents 210, 211, and 212. The supplemental content 211 that is used in the prompt is content that is associated with the interactive element that is selected by a reader.

The prompt 220 is fed to LLM 230. According to various embodiments, the LLM includes but is not limited to, a Generative Pre-trained Transformer-3 (GPT-3), Generative Pre-trained Transformer-J (GPT-J), Generative Pre-trained Transformer-4 (GPT-4), Text-to-Text Transfer Transformer (T5), Bidirectional and Auto-Regressive Transformers (BART), Language Model for Dialogue Applications (LaMDA), Large Language Model Meta AI (LLaMA), and the like, and more.

The LLM 230 is configured to browse for web information that is relevant to the prompt and to yield an output to the UD 150 based on the prompt and the web information that is relevant to the prompt.

As a non-limiting, illustrative example, the LLM 230 receives a prompt 220 that includes main content about mountains in British Columbia, Canada. The prompt 220 also includes supplemental content 211 about, for example, ice climbing in a particular mountain range when a reader selects a particular interactive element, e.g., a QR code, that links to such content about ice climbing. The prompt 220 also includes reader parameters such as the reader's age, location, and time. The LLM 230 browses information, including but not limited to, about where the reader can purchase ice climbing equipment near the reader, about weather conditions of ice climbing locations near the reader, and up-to-date government regulations about ice climbing safety.

The LLM 230 sends an output, based on the prompt 220, to the UD 150. The UD 150 is configured to display the output to the reader. Additionally, the UD 150 is configured to allow the reader to provide feedback on the output sent by the LLM 230. The reader may also interact further by responding to the output of the LLM 230, e.g., asking follow-up questions or providing clarification. The UD 150 updates the prompt 220 with the feedback and reader responses to the output of the LLM 230.

The updated prompt 220 is then fed back to the LLM 230, and the LLM 230 sends a new output to the UD 150. The reader may continue to, via the UD 150, provide further feedback and responses to new outputs of the LLM 230.

In an embodiment, the prompt engine 130 is configured to display the pre-defined prompt 220 to a reader via the UD 150 based on the enrichment point associated with the interactive element that a reader selects. According to this embodiment, the prompt engine 130 receives interactions with the pre-defined prompt 220 at each enrichment point from a plurality of readers interacting with each enrichment point. Based on the content of the interactions with the pre-defined prompt 220, the prompt engine 130 updates the pre-defined prompt at periodic intervals to ensure that the prompt takes into consideration the preferences and interactions of a plurality of readers, not just one reader.

FIG. 3 is an example flowchart 300 of a process for dynamically generating a prompt based on, and in response to, a selection of an interactive element at an enrichment point in a publication. In an embodiment, the process is executed by the prompt engine 130.

At S310, main content and supplemental content of a publication is retrieved. In an embodiment, the main content and supplemental content are retrieved from the database 140 by the prompt engine 130. The main content and supplemental content are retrieved to provide context for the generation of a set of prompts based on a reader selection of an interactive element, as discussed in more detail below.

At S320, reader parameters are received. In an embodiment, parameters of a reader include, but are not limited to, location, time, and personal data. In an embodiment, the prompt engine 130 may receive these parameters sent by the reader via the UD 150 over the network 110.

In an embodiment, receiving parameters of a reader in conjunction with the main content and supplemental content allows for the generation of a set of prompts that are relevant to the reader based on the main content at the enrichment point, the supplemental content associated with the interactive element that the reader selects, and the reader's unique information.

As a non-limiting example, a reader is reading a physical book about various species of birds. A reader scans an interactive element, such as a QR code, at an enrichment point where the book discusses the migration patterns of birds in the East of the North America. Because the reader's parameters include his or her location and time, the prompt that is generated may relate to the timing and location of a particular bird species migration through the reader's location.

At S330, a prompt based on, and in response to, a selection of an interactive element is generated. In an embodiment, the prompt is generated by the prompt engine 130. In an embodiment, a reader may select the interactive element at an enrichment point in the publication via the UD 150. Supplemental content that corresponds to, and is associated with, the selected interactive element, the main content, and the parameters of the reader are synthesized to generate a prompt that is relevant not only to the enrichment point and the supplemental content but also to the reader based on the parameters.

At S340, the prompt is fed to at least one AI model. In an embodiment, the at least one AI model may be at least one language model or large language model (LLM) such as, but not limited to, Generative Pre-trained Transformer-3 (GPT-3), Generative Pre-trained Transformer-J (GPT-J), Generative Pre-trained Transformer-4 (GPT-4), Text-to-Text Transfer Transformer (T5), Bidirectional and Auto-Regressive Transformers (BART), Language Model for Dialogue Applications (LaMDA), Large Language Model Meta AI (LLaMA), and the like, and more.

In an embodiment, the prompt engine 130 inputs the prompt into the at least one AI model. Additionally, the at least one AI model has the ability to browse publicly available data, for example, via the network 110.

At S350, the output of the at least one AI model is displayed to the reader. In an embodiment, the output is displayed on the user device 150. Once the output is displayed to the reader, the reader may interact with the output by sending feedback or follow-up queries to the at least one AI model.

In an embodiment, the prompt engine 130 is configured to display the pre-defined prompt 220 to a reader via the UD 150 based on the enrichment point associated with the interactive element that a readers selects. According to this embodiment, the prompt engine 130 receives interactions with the pre-defined prompt 220 at each enrichment point from a plurality of readers interacting with each enrichment point. Based on the content of the interactions with the pre-defined prompt 220, the prompt engine 130 updates the pre-defined prompt at periodic intervals to ensure that the prompt takes into considerations the preferences and interactions of a plurality of readers, not just one reader.

As a non-limiting, illustrative example, the reader may select an interactive element at an enrichment point in a publication about astronomy. The pre-defined query associated with the enrichment point to be inputted into an LLM is, for example, “tell me more about the solar system.” In a response to the output of the prompt, the reader queries the LLM via the prompt engine 130 with “how many moons does Jupiter have?” If a sufficient number of readers interacting with the same publication about astronomy at the same enrichment point query the initial output of the LLM with the same or a sufficiently similar query about the moons of Jupiter, then the initial prompt “tell me more about the solar system,” will be updated. As an example, the updated prompt may be “tell me more about the solar system and provide specific information about the moons of Jupiter.”

In one embodiment, the initial query is updated at regular, periodic intervals. In another embodiment, the initial query is updated dynamically, not at regular intervals. In yet another embodiment, the number of readers responding sufficiently similarly to the initial query is sufficient when the number reaches a pre-determined threshold value. Such pre-determined threshold value may, in another embodiment, be updated dynamically. Additionally, in an embodiment, the reader responses to an initial query used to update the query may not be in response to the same enrichment point but with enrichment points similar or related in content.

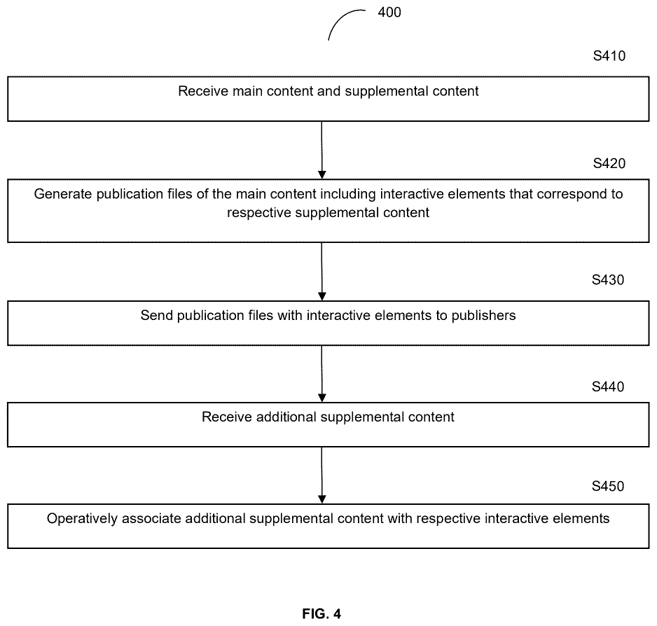

FIG. 4 is an example flowchart 400 of a process for generating dynamically enriched publications. In an embodiment, the process is executed by the publishing engine 120.

At S410, main content and supplemental content is received. In an embodiment, receiving the main content and supplemental content includes storing the contents in a database. The contents that are received are used to generate publication files that include the main content and interactive elements that are associated with the supplemental content.

At S420, publication files of the main content including interactive elements that correspond to respective supplemental content are generated. In an embodiment, the publication files are generated by the publishing engine 120. In an embodiment, the main content is converted into various media formats, including, but not limited to, Portable Document Format (PDF) and Microsoft® Word Document (DOC). Additionally, the interactive elements are generated at enrichment points in the main content. The interactive elements link to supplemental content that corresponds to the respective enrichment points in the main content.

In an embodiment, an enrichment point for the interactive element may be a location in various points in the main content of the publication including, but not limited to, the margin of a page, on a separate page, between paragraphs, in the header of a page, in a footer of a page, or on a word(s) e.g., a hyperlink in the case of an electronic publication.

At S430, publication files including the interactive elements are sent to publishing services. In an embodiment, the publication files that include the interactive elements are sent to publishing services. The publication files do not themselves contain the supplemental content, but the supplemental content can be fetched by selecting respective interactive elements. Thus, in an embodiment, supplemental content can be added, deleted or modified after the publication files are sent to publishing services.

In an embodiment, if electronic publication files are sent to electronic publishing services, new enrichment points may be identified and new interactive elements may be added at those identified enrichment points, which point to new or existing supplemental content. In another embodiment, electronic publication files allow for the removal or re-location of existing interactive elements.

At S440, additional supplemental content is received. In an embodiment, the additional supplemental content is received from, and added by the author in, a UD 150. In an embodiment, the addition of new supplemental content allows for the dynamic enrichment of the main content. For example, an author may revise, remove or add supplemental content after the interactive elements that point to the supplemental content is generated in the publication files. This allows an author to curate the information to provide greater enrichment of the main content based on the author's change viewpoint, new research, or any other reason. This allows an author to keep the supplemental content up-to-date and provide readers with the most relevant information to augment their reading experience.

At S450, the additional supplemental content is operatively associated with respective interactive elements. Once the additional supplemental content is received, it is operatively associated with respective interactive elements. The operative association serves to link the additional supplemental content to the respective interactive elements so that when a reader selects the interactive element, the additional supplemental content will be provided to the reader.

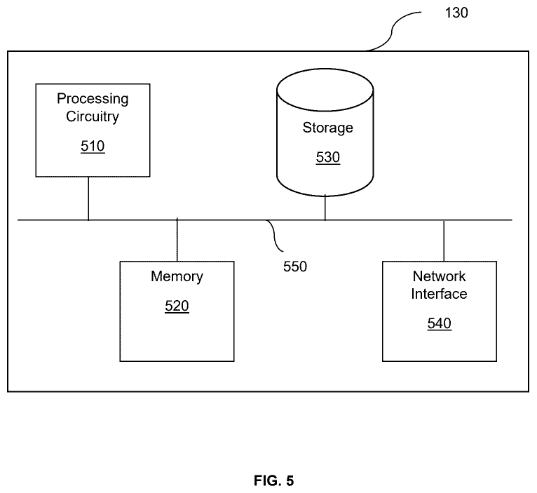

FIG. 5 is an example schematic diagram of a prompt engine 130 according to an embodiment. The prompt engine 130 includes a processing circuitry 510 coupled to a memory 520, a storage 530, and a network interface 540. In an embodiment, the components of the prompt engine 130 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 520 may be volatile (e.g., random access memory, etc.), non-volatile (e.g., read only memory, flash memory, etc.), or a combination thereof.

In one configuration, software for implementing one or more embodiments disclosed herein may be stored in the storage 530. In another configuration, the memory 520 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein.

The storage 530 may be magnetic storage, optical storage, and the like, and may be realized, for example, as flash memory or other memory technology, compact disk read-only memory (CD-ROM), Digital Versatile Disks (DVDs), or any other medium which can be used to store the desired information.

The network interface 540 allows the prompt engine 130 to communicate with, for example, the user device 150, the databases 140, the publishing engine 120, and the like.

It should be understood that the embodiments described herein are not limited to the specific architecture illustrated in FIG. 5, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for generating personalized, dynamically-enriched publications, comprising:
receiving main content and supplemental content for a publication, wherein the supplemental content supplements the main content and is associated with interactive elements at various enrichment points in the main content;
receiving reader parameters, wherein the reader parameters include data about a reader;
upon a reader selection of an interactive element of the interactive elements at an enrichment point, generating a prompt;
feeding the prompt to a large language model (LLM); and
sending an output of the LLM to the reader, wherein the LLM is configured to receive further prompts from the reader.

2. The method of claim 1, wherein the prompt is based on the reader parameters, the main content associated with the enrichment point, and the supplemental content associated with the selected interactive element.

3. The method of claim 1, wherein the prompt is a pre-configured template that includes placeholders respectively allocated for the relevant main content, the relevant supplemental content, and reader parameters.

4. The method of claim 1, further comprising:
receiving interactions of a plurality of readers with a pre-defined prompt associated with a selected interactive element, wherein interactions include the content of further prompts fed by the plurality of readers to the LLM; and
updating the pre-defined prompt based on common attributes of the interactions of the plurality of readers, wherein the pre-defined prompt is updated if there are a sufficient number of interactions with the common attributes.

5. The method of claim 1, wherein when a publication is an electronic publication, the interactive elements are hyperlinks.

6. The method of claim 1, wherein when a publication is a physical paper publication, the interactive elements are quick-response (QR) codes.

7. The method of claim 1, wherein the supplemental content further includes at least one of: news feeds, weather feeds, and stock feeds.

8. The method of claim 1, wherein reader parameters include at least one of: age, location, and time.

9. The method of claim 1, wherein the LLM is configured to browse publicly available data over a network that is relevant to answering the prompt.

10. The method of claim 1, wherein the publication is any one of: a printed document and a digital document.

11. A non-transitory computer-readable medium storing a set of instructions for generating the personalized set of instructions comprising:
one or more instructions that, when executed by one or more processors of a device, cause the device to:
receive main content and supplemental content for a publication, wherein the supplemental content supplements the main content and is associated with interactive elements at various enrichment points in the main content;
receive reader parameters, wherein the reader parameters include data about a reader;
upon a reader selection of an interactive element of the interactive elements at an enrichment point, generate a prompt;
feed the prompt to a large language model (LLM); and
send an output of the LLM to the reader, wherein the LLM is configured to receive further prompts from the reader.

12. A system for generating personalized, dynamically-enriched publications comprising:
one or more processors configured to:
receive main content and supplemental content for a publication, wherein the supplemental content supplements the main content and is associated with interactive elements at various enrichment points in the main content;
receive reader parameters, wherein the reader parameters include data about a reader;
upon a reader selection of an interactive element of the interactive elements at an enrichment point, generate a prompt;
feed the prompt to a large language model (LLM); and
send an output of the LLM to the reader, wherein the LLM is configured to receive further prompts from the reader.

13. The system of claim 12, wherein the prompt is based on the reader parameters, the main content associated with the enrichment point, and the supplemental content associated with the selected interactive element.

14. The system of claim 12, wherein the prompt is a pre-configured template that includes placeholders respectively allocated for the relevant main content, the relevant supplemental content, and reader parameters.

15. The system of claim 12, wherein the one or more processors are further configured to:
receive interactions of a plurality of readers with a pre-defined prompt associated with a selected interactive element, wherein interactions include the content of further prompts fed by the plurality of readers to the LLM; and
update the pre-defined prompt based on common attributes of the interactions of the plurality of readers, wherein the pre-defined prompt is updated if there are a sufficient number of interactions with the common attributes.

16. The system of claim 12, wherein when a publication is an electronic publication, the interactive elements are hyperlinks.

17. The system of claim 12, wherein when a publication is a physical paper publication, the interactive elements are quick-response (QR) codes.

18. The system of claim 12, wherein the supplemental content further includes at least one of:
news feeds, weather feeds, and stock feeds.

19. The system of claim 12, wherein reader parameters include at least one of:
age, location, and time.

20. The system of claim 12, wherein the LLM is configured to browse publicly available data over a network that is relevant to answering the prompt.

21. The system of claim 12, wherein the publication is any one of:
a printed document and a digital document.
